(19) United States
(12) Patent Application Publication
(10) Pub. No.: US 2018/0106097 A1
(43) Pub. Date: Apr. 19, 2018

(54) Recessed Window Assembly and Corresponding Method

(71) Applicant: Scott Lewis Ralston, Coeur d'Alene, ID (US)

(72) Inventor: Scott Lewis Ralston, Coeur d'Alene, ID (US)

(21) Appl. No.: 15/782,511

(22) Filed: Oct. 12, 2017

Related U.S. Application Data
(60) Provisional application No. 62/408,361, filed on Oct. 14, 2016.

(51) Int. Cl. E06B 3/46; E06B 1/36; E06B 1/26; E06B 9/52; E06B 9/04; E06B 5/10; E06B 7/04; E05D 15/06

(52) U.S. Cl. CPC E06B 3/4609; E06B 1/36; E06B 1/26; E06B 9/52; E06B 2007/023; E06B 5/10; E06B 7/04; E05D 15/06; E06B 2009/527; E06B 9/04

(57) ABSTRACT

A recessed window assembly comprises a housing configured for recessed installation within a frame wall of a building adjacent a window opening and at least two sliding window components slidingly disposed within the housing such that the sliding window components are at least substantially disposed within the housing when in a non-deployed position and that fill the window opening when in a deployed position. The window components can comprise, for example, a transparent untinted window, a transparent tinted window, a translucent window, a window screen, a security plate, an electric fan, or an air filter.

### RELATED APPLICATION(S)

This application claims the benefit of U.S. Provisional application No. 62/408,361 filed Oct. 14, 2016, which is incorporated by reference in its entirety herein.

### TECHNICAL FIELD

These teachings relate generally to windows.

### BACKGROUND

Windows are known in the art. As used herein, a window will be understood to constitute a built-in panel for an opening in a wall. Windows are often formed of glass or other transparent or translucent material in order to permit light to pass therethrough. Some windows are fixed in place and cannot be opened. Many windows are configured, however, to be selectively opened and closed to permit air to pass therethrough.

Many windows are so-called double hung windows (also sometimes called sash windows). These windows are comprised of movable panels that permit part of the covering for the window opening to be moved to thereby open the window. Generally speaking, no more than one half the window opening can be opened with such a window. Such limitations to how far a window can be opened can detrimentally affect the ability of the user to achieve, for example, a desired level of airflow through the window opening.

Some windows, such as the so-called casement window, provide a hinge at the side of the window to permit the window to be moved about the hinge. Such a hinge can allow the window to be moved to open more than one half of the window opening. Such an approach, however, presents other sometimes undesirable concerns. For example, this approach causes the window to be extended outwardly or inwardly in a way that can cause contact or a risk of contact with nearby features or persons.

In addition, while a number of different window panels are available, the user must typically select only one or two such panels (such as a pane of transparent or frosted glass and a window screen) for use in a single window opening. Once selected, it can be very difficult and/or expensive to make a later change in these regards.

### BRIEF DESCRIPTION OF THE DRAWINGS

The above needs are at least partially met through provision of the recessed window assembly and corresponding method described in the following detailed description, particularly when studied in conjunction with the drawings, wherein:

FIG. 1 comprises a perspective schematic view as configured in accordance with various embodiments of these teachings;

FIG. 2 comprises a flow diagram as configured in accordance with various embodiments of these teachings;

FIG. 3 comprises a front elevational view as configured in accordance with various embodiments of these teachings;

FIG. 4 comprises a side elevational cutaway view as configured in accordance with various embodiments of these teachings; and

FIG. 5 comprises a top plan cutaway view as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a recessed window assembly comprises a housing configured for recessed installation within a frame wall of a building adjacent a window opening and at least two sliding window components slidingly disposed within the housing such that the sliding window components are at least substantially disposed within the housing when in a non-deployed position and that fill the window opening when in a deployed position. These teachings will accommodate a variety of different sliding window components including, but not limited to, a transparent untinted window, a transparent tinted window, a translucent window, a window screen, a security plate, an electric fan, and an air filter to note but a few examples in these regards.

These teachings readily accommodate installing such a recessed window assembly in a frame wall of a building. Such installation includes forming a window opening in the frame wall and forming a recess in the frame wall adjacent to that window opening. The aforementioned recessed window assembly is then installed substantially fully within that recess.

By one approach the aforementioned sliding window components are non-temporarily coupled with respect to the aforementioned housing. By another approach one or more of the sliding window components can be readily removed from the housing to facilitate, for example, cleaning the sliding window components and/or the housing and/or to facilitate replacing the removed sliding window component with a different sliding window component.

So configured, such a window can be opened fully or nearly fully to thereby selectively fully expose the window opening in a convenient manner. Generally speaking, the sliding window components will not require intermediary structures such as support posts and accordingly the view through the window will be unobstructed. By one approach, when using both a transparent window and a window screen, the window screen can be withdrawn to within the housing when the transparent window is fully closed to thereby provide an unobstructed view through the transparent window.

Such a recessed window assembly can be manufactured off-site as a substantially complete unit that is then installed in a relatively simple manner at an appropriate point during construction of a building's walls. Accordingly, these teachings can be readily leveraged to achieve both high quality and low cost results.

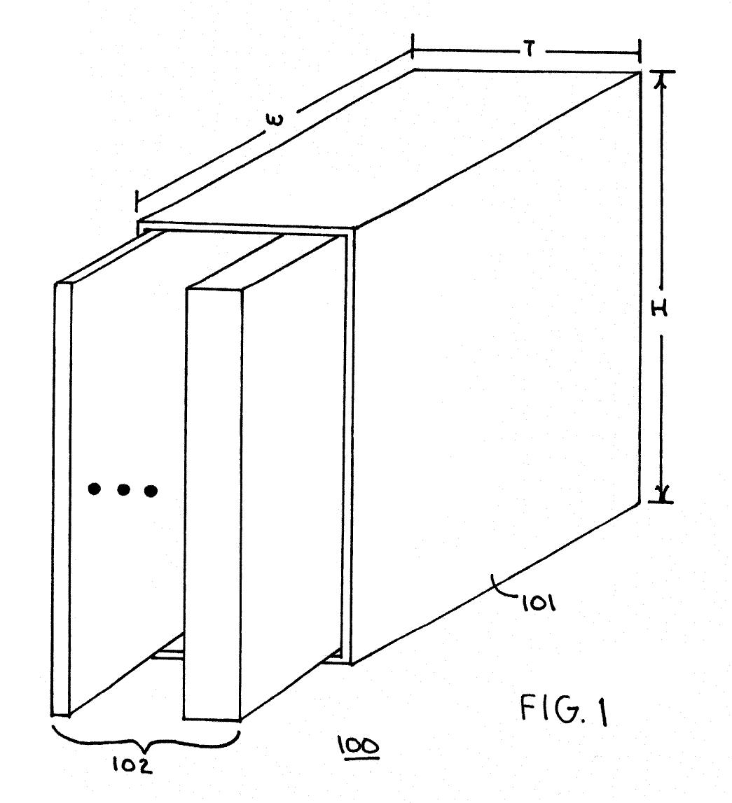

These and other benefits may become clearer upon making a thorough review and study of the following detailed description. Referring now to the drawings, and in particular to FIG. 1, an illustrative example of a recessed window assembly 100 will be described. This window assembly is referred to as a “recessed” window assembly because the window assembly is recessed (i.e., set back and located within a space or opening) within a wall when properly installed.

This recessed window assembly 100 includes a housing 101. This housing 101 comprises an open-sided box that is configured for recessed installation within a frame wall of a building adjacent a window opening. (A frame wall will be understood to refer to a wall that is formed of framing materials such as wood, engineered wood, or structural steel. Those framing materials are typically connected in various horizontal, vertical, and diagonal orientations to one another to form a structural skeleton over which a covering material, such as wallboard or plywood, is then applied. A frame wall typically includes a considerable amount of open space between the framing materials that is sometimes filled with insulating materials such as fiberglass batting or the like.)

The open-sided box that comprises the housing 101 can be formed of any suitable material including, in whole or in part, various plastics and metals. For many application settings it can be beneficial for the various sides of the open-sided box (other than the open side itself) to be closed and without holes or other apertures through which potential contaminants may enter the housing 101. Being sealed in these regards can help protect the operational integrity of the assembly during shipping and following installation in a wall.

The height “H” and width “W” of the housing 101 can be as desired. These teachings will accommodate essentially any sized window opening of interest. The primary thickness “T” dimension of the housing 101, however, will usually be selected to assure a non-invasive placement within a frame wall. Accordingly, this thickness T of the housing 101 will typically not exceed about 3.5 inches (to accommodate framing that utilizes 2×4 inch lumber) or that does not exceed about 5.5 inches (to accommodate framing that utilizes 2×6 inch lumber).

The recessed window assembly 100 also comprises at least two sliding window components 102. These sliding window components 102 are slidingly disposed within the housing 101 such that the sliding window components 102 are at least substantially disposed (for example, at least 90 percent, or 95 percent, or even 100 percent as desired) within the housing 101 when in a non-deployed position. Per these teachings these sliding components will fill the aforementioned corresponding window opening when in a deployed position.

These teachings will accommodate a variety of approaches in these regards. By one approach, for example, the bottom and/or top edges of the sliding window components 102 are disposed within and slide along narrow tracks that guide the sliding window components 102 as they slide and that prevent the sliding window components 102 from undue lateral movement or positioning. By another approach, in lieu of the foregoing or in combination therewith, one or more rollers or other rotating components can be used to help facilitate the sliding movement of the sliding window components 102.

If desired, each (or some) of the sliding window components 102 can include a detent or outwardly-extending tab or the like that a user can grasp and manipulate to physically individually move the sliding window components 102 between fully non-deployed and fully deployed positions. Also if desired, the housing 101 can be equipped with an electrically-powered drive mechanism of choice to cause selected ones of the sliding window components 102 to selectively move between such positions. Generally speaking, the sliding window components 102 are disposed to move horizontally between deployed and non-deployed positions rather than, say, vertically.

These teachings are highly flexible in practice and will accommodate a wide variety of different sliding window components. By one approach, for example, one or more of the sliding window components 102 comprise transparent tinted or untinted windows. (As used herein, the word “transparent” will be understood to refer to a substantially undistorted passage of light, such as less than 5 percent, 3 percent, or 1 percent of distortion. As used herein, the word “tint” will be understood to refer to the presence of a color in the window material (or to a conformal covering that is applied to the window) while the word “untinted” will be understood to refer to an absence of color in the foregoing regards.)

By another example one or more of the sliding window components 102 can comprise a translucent window. (As used herein, the word “translucent” will be understood to refer to a distorted passed of light (due, for example, to a change in an index of refraction). Accordingly, to be “translucent” is to permit the passage of light (and hence is different than being opaque) albeit without clarity.) For example, so-called frosted glass is an example of a translucent window that is sometimes formed via sandblasting or acid etching that creates a pitted surface on a glass panel to thereby create a particular type of translucency caused by the scattering of light passing through that panel to thereby blur the resultant view through the window. Such a translucent window can be tinted or untinted as desired.

As yet another example, one or more of the sliding window components 102 can comprise a window screen. Such screens typically comprise a fine mesh made of metal wire, fiberglass, synthetic fiber, or the like and serve to permit the passage of air while blocking leaves, debris, insects, and birds.

As yet another example, one or more of the sliding window components 102 can comprise a security plate. Such a security plate may comprise, for example, a metal or strong plastic plate that can serve to deflect and prevent airborne objects from entering through the window opening and/or to prevent a person or animal from making an unauthorized entry through the window opening. Such a security plate might find frequent use (when, for example, the homeowner uses the security plate to protect a window near a basketball hoop in the front driveway) or only occasional use (when, for example, the homeowner uses the security plate to help protect a home during a strong storm such as a hurricane).

In a typical application setting it can be useful for the security plate to be disposed more towards the exterior side of the frame wall than any of the remaining sliding window components. As a simple example, when a particular recessed window assembly 100 has three sliding window components 102 comprising a transparent untinted window, a window screen, and a security plate, the security plate can be disposed more towards the exterior side of the frame wall than either of the transparent untinted window and the window screen.

And as yet another example, one or more of the sliding window components 102 can comprise an electric fan. Accordingly, and as generally illustrated in FIG. 1, the sliding window components 102 can have different thicknesses as compared to one another to accommodate the form factor of the makeup and or functionality of the sliding window component 102 itself. Generally speaking, an electric fan sliding window component will likely have a larger thickness than, say, a window screen or a transparent window. Such an electric fan can be configured to move air from the exterior side of the wall to the interior side, or the opposite, as desired. These teachings will also accommodate a selective ability to choose the direction of air movement.

And as yet another example, one or more of the sliding window components 102 can comprise an air filter. These teachings will accommodate either or both passive air filters and active air filters as desired. Generally speaking the purpose of such an air filter is to filter out airborne contaminants (such as pollen or smoke particles) from air that is entering into a building via the window opening.

As noted above the recessed window assembly 100 includes at least two such sliding window components. By one approach the two or more sliding window components are all identical, or substantially identical to one another. By another approach the sliding window components 102 are all categorically different from one another (and therefore comprise different types of window components). When only two sliding window components 102 are provided, in many application settings it may be beneficial for the two sliding window components 102 to comprise a transparent untinted window and a window screen.

As already noted, these teachings will accommodate more than two sliding window components 102. For example, a given recessed window assembly 100 may have three sliding window components that are slidingly disposed within the housing 101. In this case, in some application settings it would be useful to have a transparent untinted window, a window screen, and a security plate as described above.

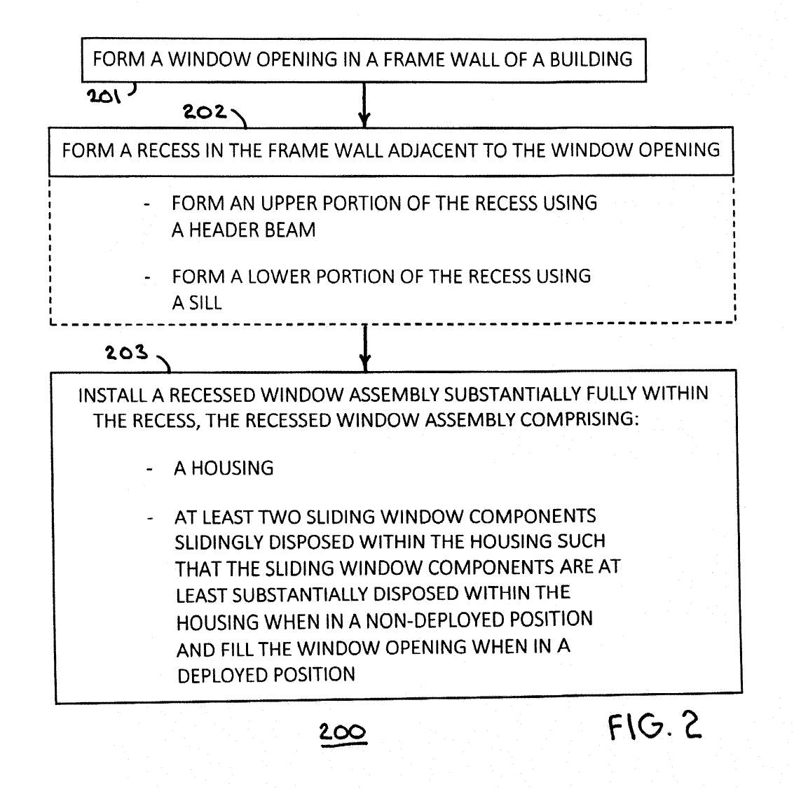

Referring now to FIGS. 2-5 an illustrative example of a process 200 for installing such a recessed window assembly 100 in a frame wall 301 will be described. It will be understood that the specifics of this example are intended to serve an illustrative purpose and are not meant to suggest any particular limitations as regards this invention.

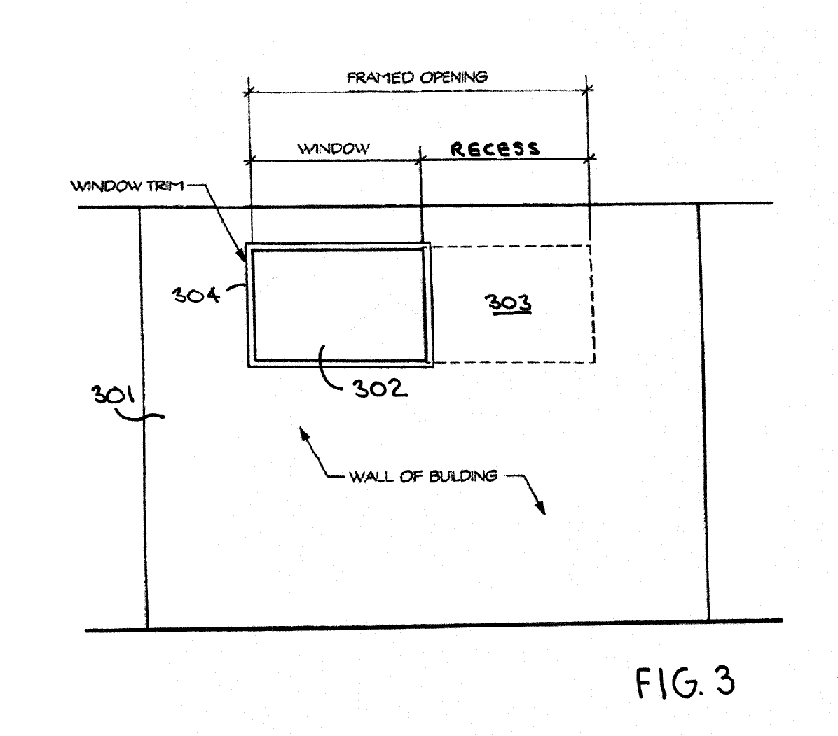

At block 201 of this process 200 (FIG. 2), a window opening 302 is formed in a frame wall 301 of a building (as shown in FIGS. 3-5s). These teachings are applicable in a wide variety of buildings including but not limited to residences, commercial and office buildings, industrial facilities, public buildings, and so forth. This opening will serve to receive the sliding window components 302 described above when such component are at least partially withdrawn from within the housing 301 of the installed recessed window assembly 100 and placed in a deployed position.

Window trim 304 of choice can be placed around the window opening 302 as desired, on either or both the interior and exterior sides of the wall 301.

At block 202 of this process 200 a recess 303 is formed in the frame wall 301 adjacent the aforementioned window opening 302. In a typical application setting the recess 303 will be immediately adjacent the window opening 302 such that there are no other components or construction materials disposed between the recess 303 and the window opening 302.

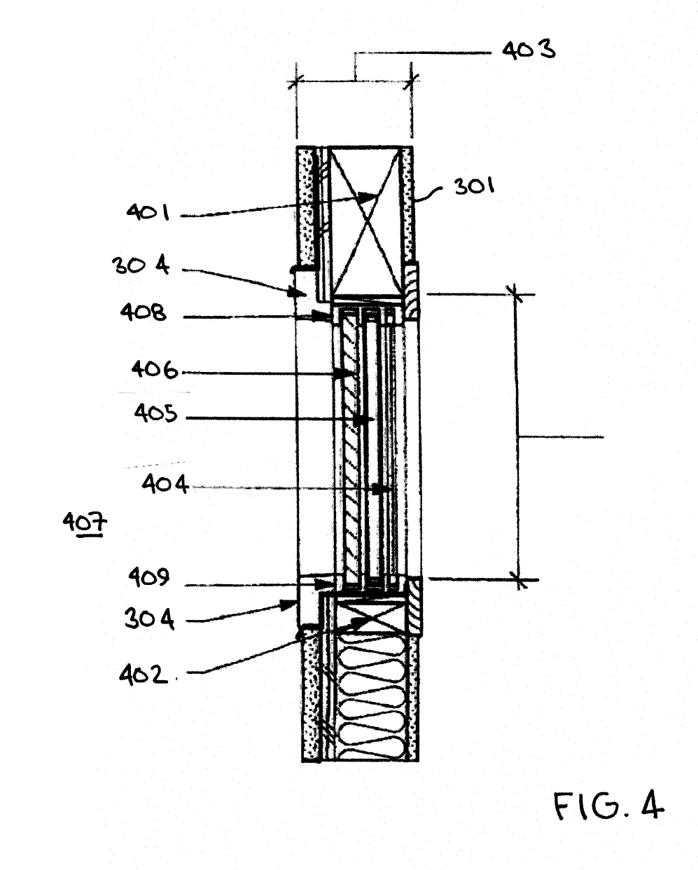

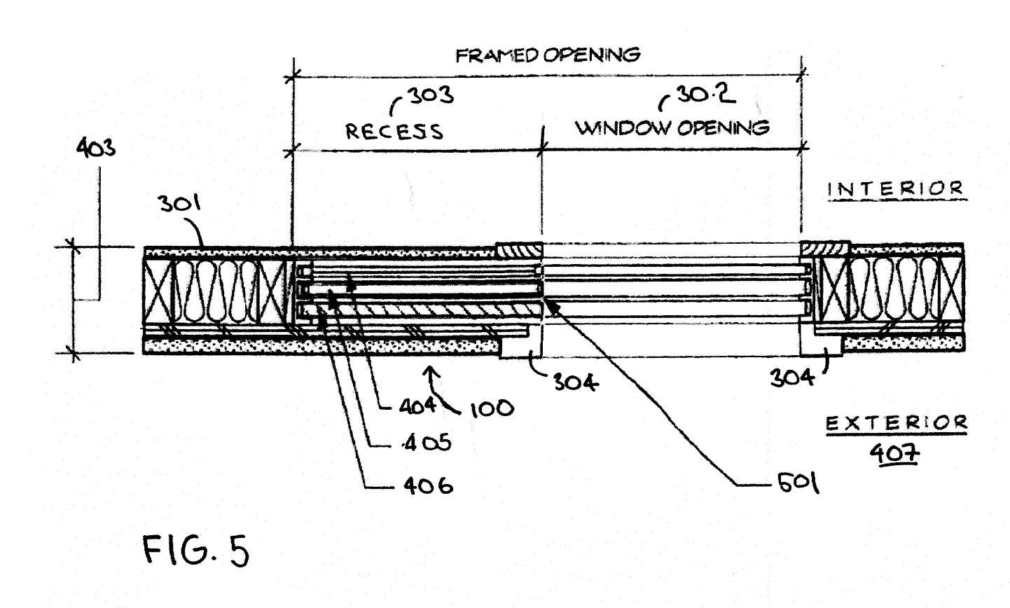

By one optional approach (as suggested in FIG. 2 and illustrated in FIGS. 4 and 5), the recess 303 (and also the window opening 304, if desired) can be formed, at least in part, by using a header beam 401 (FIG. 4) to form the upper portion thereof and a sill 402 (FIG. 4) to form the lower portion thereof. Such an approach can be particularly useful when the frame wall 301 is otherwise comprised of typical 2×4 (or 2×6) wooden framing materials as illustrated. Such wooden frame walls are very well known in the art and require no further elaboration here.

At block 203 of this process 200, the above-described recessed window assembly 100 is installed substantially fully within the aforementioned recess 303. (As used in these regards, the expression “substantially fully” will be understood to mean that at least 90 percent of the housing 101 is installed within the recess 303, though these teachings will accommodate tighter requirements, such 95 percent or even 100 percent.)

In this particular example the recessed window assembly 100 has three sliding window components 102. These three components consist of a window screen 404, a transparent untinted window 405, and a security plate 406 (the latter window component being disposed towards the exterior 407 as compared to the other two window components 404 and 405). With reference to FIG. 4 these sliding window components 102 are disposed within and between a sliding head track 408 and a sliding sill track 409. These tracks can be comprised, for example, of a suitable plastic or metal material as desired.

With reference to FIG. 5 an interlocking water tight seal 501 can be disposed at the open side of the housing 101 and can help to prevent moisture or other contaminants from gaining access to the interior of the housing 101. This seal 501 can include, for example, elastic or otherwise resilient gaskets or the like that make contact with the sliding window components 102.

It will be appreciated that such an assembly can be installed relatively easily and efficiently and without requiring any unusual or expensive secondary materials or components.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A recessed window assembly comprising:
a housing configured for recessed installation within a frame wall of a building adjacent a window opening;
at least two sliding window components slidingly disposed within the housing such that the sliding window components are at least substantially disposed within the housing when in a non-deployed position and fill the window opening when in a deployed position.

2. The recessed window assembly of claim 1 wherein the housing has a primary thickness dimension that does not exceed about 3.5 inches.

3. The recessed window assembly of claim 1 wherein the housing has a primary thickness dimension that does not exceed about 5.5 inches.

4. The recessed window assembly of claim 1 wherein the housing is at least substantially comprised of plastic.

5. The recessed window assembly of claim 1 wherein the at least two sliding window components comprise at least two of:
a transparent untinted window;
a window screen;
a security plate.

6. The recessed window assembly of claim 1 wherein the at least two sliding window components comprise at least three of:
a transparent untinted window;
a transparent tinted window;
a translucent window;
a window screen;
a security plate;
an electric fan;
an air filter.

7. The recessed window assembly of claim 1 wherein at least three sliding window components are slidingly disposed within the housing.

8. The recessed window assembly of claim 7 wherein the at least three sliding window components comprise at least three of:
a transparent untinted window;
a transparent tinted window;
a translucent window;
a window screen;
a security plate;
an electric fan;
an air filter.

9. A method of installing a window in a frame wall of a building, comprising:
forming a window opening in the frame wall;
forming a recess in the frame wall adjacent to the window opening;
installing a recessed window assembly substantially fully within the recess, the recessed window assembly comprising:
a housing;
at least two sliding window components slidingly disposed within the housing such that the sliding window components are at least substantially disposed within the housing when in a non-deployed position and fill the window opening when in a deployed position.

10. The method of claim 9 wherein forming the recess in the frame wall comprises, at least in part, forming an upper portion of the recess using a header beam and a lower portion of the recess using a sill.

11. The method of claim 9 wherein the housing has a primary thickness dimension that does not exceed about 3.5 inches.

12. The method of claim 9 wherein the housing has a primary thickness dimension that does not exceed about 5.5 inches.

13. The method of claim 9 wherein the at least two sliding window components comprise at least two of:
a transparent untinted window;
a window screen;
a security plate.

14. The method of claim 13 wherein the security plate is disposed more towards an exterior side of the frame wall than either of the window and the window screen.

15. The method of claim 9 wherein at least one of the two sliding window components comprises an electric fan.

16. A building comprising:
a plurality of frame walls;
at least one window opening formed in at least some of the plurality of frame walls;
a recessed window assembly recess formed adjacent each of the window openings;
a recessed window assembly disposed in each of the recessed window assembly recesses, each of the recessed window assemblies comprising:
a housing;
at least two sliding window components slidingly disposed within the housing such that the sliding window components are at least substantially disposed within the housing when in a non-deployed position and fill the adjacent window opening when in a deployed position.

17. The building of claim 16 wherein the frame walls have an interior depth that is between about 3.5 inches to 5.5 inches wide and wherein the housing has a thickness that does not exceed the interior depth.

18. The building of claim 17 wherein the recessed window assembly recess is bounded on an upper side by a header beam and on a lower side by a sill.

19. The building of claim 18 wherein the at least two sliding window components comprise at least two of:
a transparent untinted window;
a window screen;
a security plate.

20. The building of claim 19 wherein the security plate is disposed more towards an exterior side of the frame wall than any of the other sliding window components.
